(19) United States
(12) Patent Application Publication
(10) Pub. No.: US 2013/0339405 A1
(43) Pub. Date: Dec. 19, 2013

(54) INFORMATION PROCESSING SYSTEM, INFORMATION PROCESSING APPARATUS, CONTROL METHOD THEREFOR AND COMPUTER-READABLE STORAGE MEDIUM

(71) Applicant: CANON KABUSHIKI KAISHA, Tokyo (JP)

(72) Inventor: Nobuhiko MAKI, Tokyo (JP)

(73) Assignee: CANON KABUSHIKI KAISHA, Tokyo (JP)

(21) Appl. No.: 13/873,460

(22) Filed: Apr. 30, 2013

(30) Foreign Application Priority Data
Jun. 19, 2012 (JP) 2012-138193

(51) Int. Cl. G06F 17/30

(52) U.S. Cl. CPC G06F 17/30194
USPC 707/821

(57) ABSTRACT

An information processing system detects that an updated version of a file is registered on a server that provides a microblogging function, and acquires, in a case where it is detected that the updated version of the file is registered on the server, information indicating a user that performed a specific operation related to an original version of the file, and distributes the updated version of the file to the user indicated by the acquired information.

### BACKGROUND OF THE INVENTION

1. Field of the Invention

The present invention relates to an information processing system, an information processing apparatus that is capable of communicating with a server that provides a microblogging function, and to a control method therefor and a computer-readable storage medium.

2. Description of the Related Art

In recent years, cloud computing systems have become commonplace as a form of system that provides services using the Internet. Because of this, users, without preparing hardware resources such as a server, if they provide a minimal connection environment, can use services called cloud services provided by cloud computing systems. As for cloud services that have already been realized, there are CRM (Customer Relationship Management) services that provide CRM system functions for carrying out customer management and sales support. As for other cloud services, there are document management services that provide storage and management functions for electronic files.

Furthermore, there are also services that provide a microblogging function as a communication tool. A microblogging function is a short blog function in which users holding accounts of the service make available short messages of 100-200 characters called “microposts”. The user here is not limited to being an actual user (person); it also includes such things as, for example, image processing apparatuses (printers, multifunction peripherals, etc.), linkage services, and objects in cloud services and applications. In other words, a printer, for example, rather than an actual person, may be registered as a user having an account on the service, and the printer itself may register and make available messages, or monitor for a message by another user. A unique identifier is assigned to each message that a user makes available.

In a microblogging function, a “timeline”, which lists a message registered by a user and messages that other users registered in response to the message, through which registration, display and management is possible, is created. Users exchange information and communicate on the “timeline”. For each user account, there is a function for managing the profile of the user, so it is possible to know what kind of person a communication partner is. For example, information such as the name of the user, contact details (email address, telephone number, address, etcetera), and groups they are a part of is managed.

Amongst CRM services provided as cloud services, there are examples in which a microblogging function to be used as a communication tool during work is provided. In these cloud services, client information, business discussion information, etcetera are linked to messages in order to further improve the user's convenience of use.

Furthermore, at the same time, in CRM services, file sharing functions are provided in which files are shared between users, wherein the files can be saved, edited, updated, and referenced. With these kinds of file sharing functions, sharing is possible without distributing files individually to distribution destinations. An example of this is Chatter provided by Salesforce.com as a microblogging function. Document, File, etcetera are examples of file sharing functions. With the file sharing function of Chatter, a user can register and make available a message of their choosing along with a file, and other users can reference the file and message made available, and can acquire the file itself by downloading. Also, in a case where it is desired that a file that was made available be updated, the previously registered file is indicated, and the updated file is once again registered. For example, when a user registers a file, a message such as ““AA EXPLANATORY MEETING DOCUMENT” is in the process of being created. Please leave a comment if you have one” may be attached. Also, in a case where the file in the process of being created is completed, the message, “the document is completed” can be attached and registered once again. Other users can grasp information and status corresponding to the file made available by referring to these messages. Also, upon registering a file, a keyword can be attached as a tag, and when a file is registered attaching such a tag, it is useful for a case where files are searched.

Also, amongst image processing apparatuses improvement and increase in functions is continuing. In recent years image processing apparatuses have been developed equipped with not only the standard functions of scan and print for digitization of paper documents and printing, but also network interfaces (hereinafter referred to as “network I/F”). For example, an image processing apparatus equipped with a network I/F can send and store image data, formed by scanning a paper document, to a cloud service, and can acquire and print image data stored on the cloud service. Accordingly, by using this kind of function, distribution of image data to other users is being realized.

In Japanese Patent Laid-Open No. 2000-048024, a technique of automating fixed processing after a point where editing of a document with tags has completed based on information embedded in the tags beforehand is proposed. With this technique, by embedding distribution destination information in the tags of the document with tags, at the point when the document is completed, automatic distribution of the document to the distribution destination indicated in the distribution destination information can be performed automatically. With this, it is possible to reduce the amount of work to be done and to avoid forgetting to distribute a document.

However, the conventional technique has the following problems. In a case where making available, editing, updating or reference of a text document is performed on a file sharing function of Chatter, or the like, in order to check what kind of condition the document file is in, it is necessary for the user to check the message himself by operating the file sharing function. For example, even in the case where at the point in time when the document being created is completed it is desirable to acquire the completed document immediately, it is necessary for the user to access the file sharing function himself and to check whether or not the file is complete. Also, there are cases where inquiry to the document file provider is made just in case. This check is a cumbersome for the user, and there are also times where users forget to check.

Furthermore, when a distribution destination is embedded beforehand in a tag of a document with tags as in Japanese Patent Laid-Open No. 2000-048024, there are cases where a user that wishes to acquire the completed document is not included in the distribution destination information and cases where the distribution destination information is incorrect. In order to avoid these cases, it is necessary for the provider of the document file to carefully check whether there is anything missing in distribution destination information embedded in a tag and whether an incorrect distribution destination is included, and so on.

### SUMMARY OF THE INVENTION

An aspect of the present invention is to eliminate the above-mentioned problems with the conventional technology.

According to an aspect of the present invention, there is provided an information processing system comprising a detection unit configured to detect that an updated version of a file is registered on a server that provides a microblogging function; an acquisition unit configured to acquire, in a case where the detection unit detected that the updated version of the file is registered on the server, information indicating a user that performed a specific operation related to an original version of the file; and a distribution unit configured to distribute the updated version of the file to the user indicated by the information that the acquisition unit acquired.

Further features and aspects of the present invention will become apparent from the following description of exemplary embodiments, with reference to the attached drawings.

### BRIEF DESCRIPTION OF THE DRAWINGS

FIG. 1 is a view for describing a system configuration of an information processing system according to an embodiment of the present invention.

FIG. 2 is a block diagram for describing a hardware configuration of an image processing apparatus according to the embodiment.

FIG. 3 is a block diagram for describing a configuration example of a cloud service server according to the embodiment.

FIG. 4 is a block diagram for describing a software configuration of the image processing apparatus according to the embodiment.

FIG. 5 is a block diagram for describing a software configuration of the cloud service server according to the embodiment.

FIG. 6 is a view for showing an example of a microblog screen display on a terminal according to a microblogging function provided by the cloud service server according to the embodiment.

FIG. 7 is a flowchart for describing timeline monitoring processing by the image processing apparatus according to the embodiment.

### DESCRIPTION OF THE EMBODIMENTS

The embodiment of the present invention will be explained in detail referring to the drawings. Note, the embodiment below does not limit the present invention according to the patent claims, and it is not necessarily the case that all of the combinations of the features explained in the present embodiment are necessary for the solution method of the present invention. Note, in the present embodiment, explanation is given using a multifunction peripheral (hereinafter referred to as an image processing apparatus) 101 as the information processing apparatus of the present invention, but the present invention is not limited to this kind of image processing apparatus and a PC, or the like, having a function that can communicate with a cloud service server may alternatively be used.

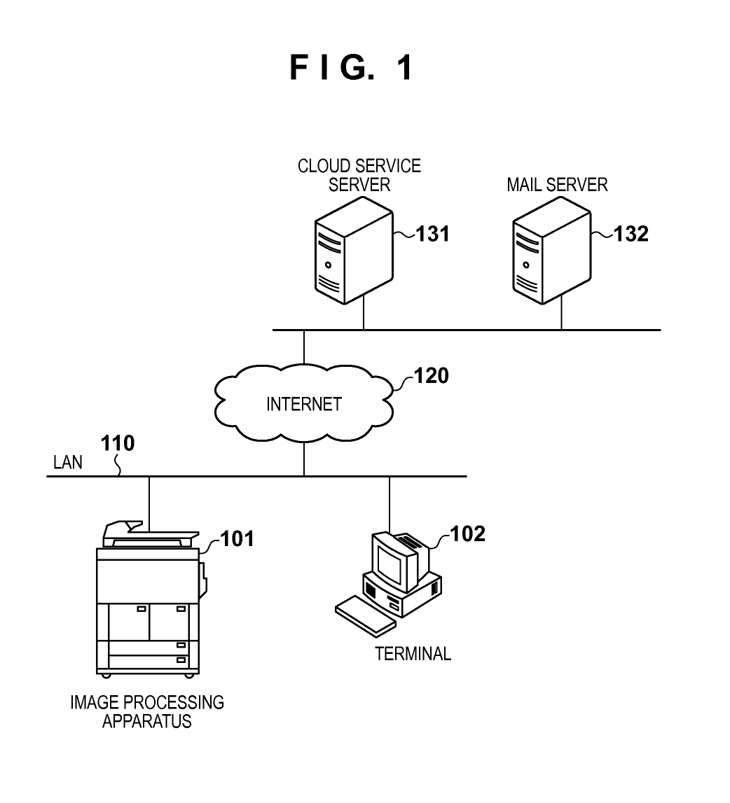

FIG. 1 is a view for describing a system configuration of an information processing system according to an embodiment of the present invention.

The information processing system of the present embodiment provides the image processing apparatus 101, a terminal 102, a cloud service server 131, and a mail server 132. On a LAN 110, the image processing apparatus 101 and the terminal (personal computer: PC) 102 are connected so as to be able to communicate. Also, the LAN 110 is connected so as to be able to communicate with the Internet 120, and is connected to the service providing cloud service server 131 via the Internet 120. The mail server 132, like the cloud service server 131, is also connected via the Internet 120. Note, here the terminal 102 is connected along with the image processing apparatus 101 to the LAN 110, but the invention is not limited to this. In other words, the terminal 102 may be connected to another LAN, as long as connection to the cloud service server 131 is possible.

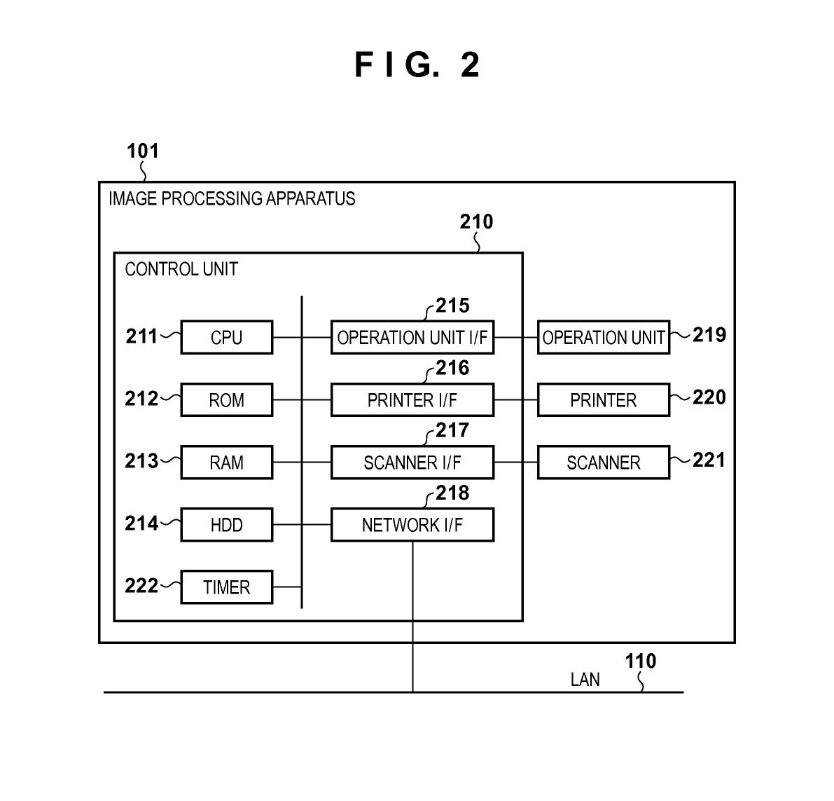

FIG. 2 is a block diagram for describing a hardware configuration of the image processing apparatus 101 according to the embodiment.

The image processing apparatus 101 provides, as a hardware configuration, a control unit 210, an operation unit 219, a printer 220 and a scanner 221. The control unit 210 comprises a CPU 211, a ROM 212, a RAM 213, an HDD 214, an operation unit I/F 215, a printer I/F 216, a scanner I/F 217, a network I/F 218 and a timer 222.

The control unit 210 controls operation of the image processing apparatus 101 on the whole. The CPU 211 loads a control program stored in the ROM 212 or the HDD 214 into the RAM 213, and performs various controls such as read out control and transmission control according to the control program. The RAM 213 is used as a temporary storage area such as a main memory or a work area for the CPU 211. The HDD 214 may store image data, various programs, various information tables and the like. The operation unit I/F 215 connects the operation unit 219 and the control unit 210. The operation unit 219 may provide, for example, an LCD unit (a display unit) having a touch panel function, a keyboard, or the like.

The printer I/F 216 connects the printer 220 and the control unit 210. Image data to be printed on the printer 220 is transferred from the control unit 210 via the printer I/F 216, and printed by the printer 220 onto a recording medium (a sheet). The scanner I/F 217 connects the scanner 221 and the control unit 210. The scanner 221 reads in an image on a document and outputs image data, and that image data is input into the control unit 210 via the scanner I/F 217. The network I/F 218 connects the control unit 210 (the image processing apparatus 101) to the LAN 110. The network I/F 218 transmits image data and information via the LAN 110 to external apparatuses, and receives from external apparatuses image data and various information. The timer 222 times a fixed time period according to instruction of the CPU 211, and when that fixed time period has passed notifies the CPU 211 with an interrupt or the like.

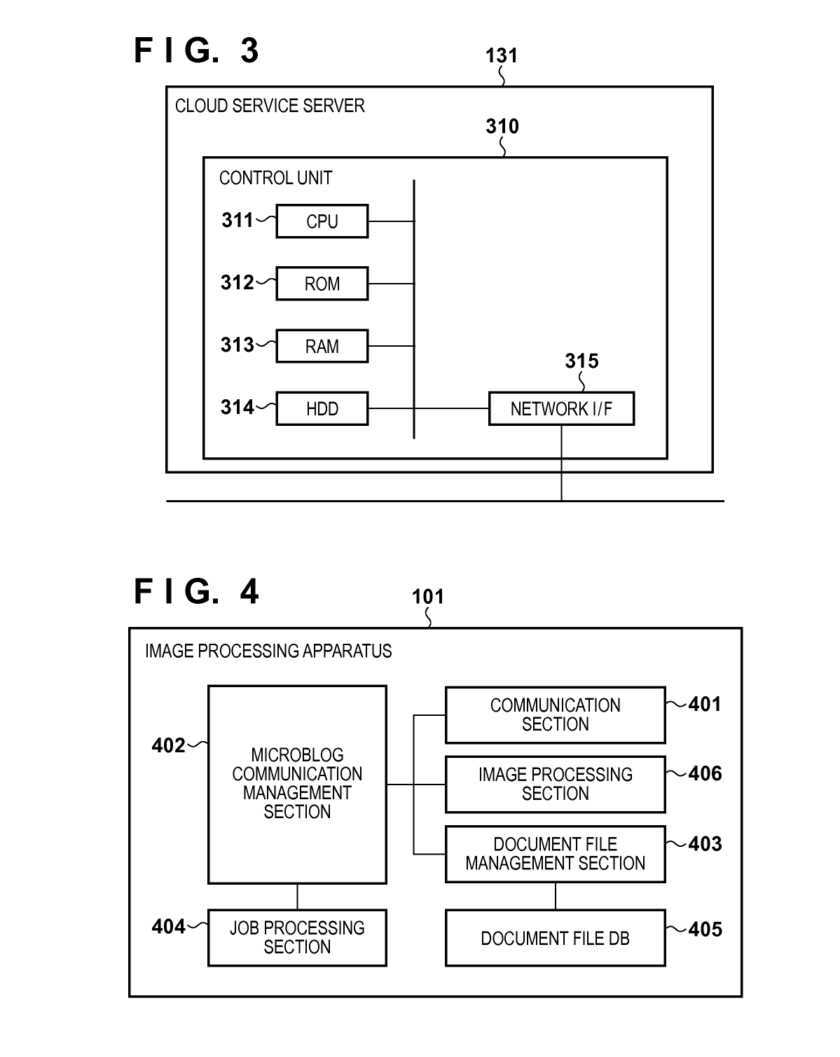

FIG. 3 is a block diagram for describing a configuration example of the cloud service server 131 according to the embodiment. Note, the hardware configurations of the mail server 132 and the terminal 102 may be the same as that of the cloud service server 131 and so their explanation is omitted.

A control unit 310, including a CPU 311, controls operation of the cloud service server 131 on the whole. The CPU 311, from a boot program stored in a ROM 312, executes various control processing according to a control program loaded from an HDD 314 into a RAM 313. The RAM 313 is used as a main memory, a work area, or the like of the CPU 311. The HDD 314 stores image data, various programs, various kinds of later explained information tables, and the like. A network I/F 315 connects the control unit 310 (the cloud service server 131) to the Internet 120. Note, a network I/F of the terminal 102 connects the terminal 102 to the LAN 110.

FIG. 4 is a block diagram for describing a software configuration of the image processing apparatus 101 according to the present embodiment. The various functional sections shown in FIG. 4 are realized by the CPU 211 of the image processing apparatus 101 executing a control program loaded into the RAM 213. The image processing apparatus 101 has, as a software configuration, a communication section 401, a microblog communication management section 402, a document file management section 403, a job processing section 404, a document file database (hereinafter referred to as a document file DB) 405, and an image processing unit 406.

The communication section 401 transmits a request to the cloud service server 131 according to an instruction from the microblog communication management section 402. Also, the communication section 401 receives a response (a reply to the request) from the cloud service server 131. Further, there are cases where the communication section 401 transmits email to/receives email from the mail server 132.

By giving various instruction to the microblog communication management section 402, the communication section 401, the document file management section 403, the job processing section 404 and the image processing section 406, the functions of the present embodiment are realized.

The document file management section 403 makes an instruction to store a document file acquired by the microblog communication management section 402 to the document file DB 405 and acquires document files stored in the document file DB 405. The job processing section 404 makes requests to the control unit 210 for execution of various jobs according to execution instructions from the microblog communication management section 402. The document file DB 405 stores document files acquired by the microblog communication management section 402 according to instruction from the document file management section 403 into memory of the HDD 214 or the like. Also, the document file DB 405 acquires document files stored in memory of the HDD 214, or the like, and transmits the document files to the document file management section 403. The image processing section 406 performs conversion processing of document file data into PDF, XPS, OOXML, and other such electronic file formats.

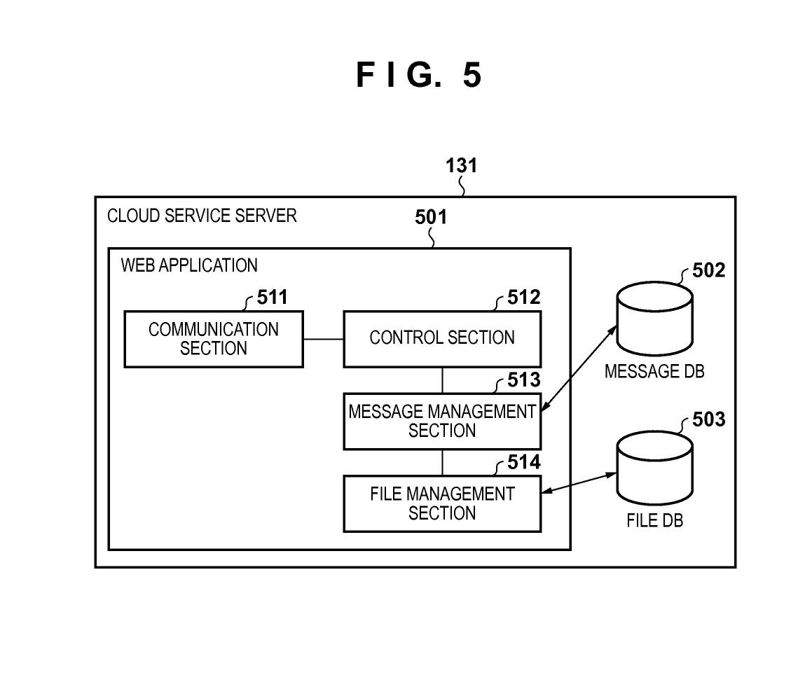

FIG. 5 is a block diagram for describing a software configuration of the cloud service server 131 according to the embodiment. The various functional sections shown in FIG. 5 are realized by the CPU 311 of the cloud service server 131 executing a control program loaded into the RAM 313.

The cloud service server 131 has a Web application 501, a message database 502 (hereinafter referred to as a message DB) and a file database 503 (hereinafter referred to as a file DB). The Web application 501 is a Web application for providing a CRM service. In the present embodiment, a microblogging function is provided in the Web application 501. The Web application 501 has a communication section 511, a control section 512, a message management section 513 and a file management section 514.

The communication section 511 receives a request from the image processing apparatus 101 or the terminal 102 (PC, etc.), and transmits the content of the request to the control section 512. Furthermore, the communication section 511 receives a processing result corresponding to the request from the control section 512, and generates and transmits to the image processing apparatus 101 or the terminal 102 response data corresponding to the request. The control section 512, according to the content of the request transmitted from the communication section 511 extracts a message included in the request and makes a request to the message management section 513 for registration processing of the message. The message management section 513 receives a message transmitted from the control section 512 and stores it in the message DB 502. Also, the message management section 513 according to the request from the control section 512, acquires a message registered in the message DB 502 from the message DB 502, and transmits it to the control section 512. The control section 512 extracts, in a case where a file is included in the content of a request transmitted from the communication section 511, the file, and makes a request to the file management section 514 for registration processing of the file. The file management section 514 receives a file transmitted from the control section 512 and stores it in the file DB 503. Also, the file management section 514, according to a request from the control section 512, acquires a file registered in the file DB 503 from the file DB 503 and transmits it to the control section 512.

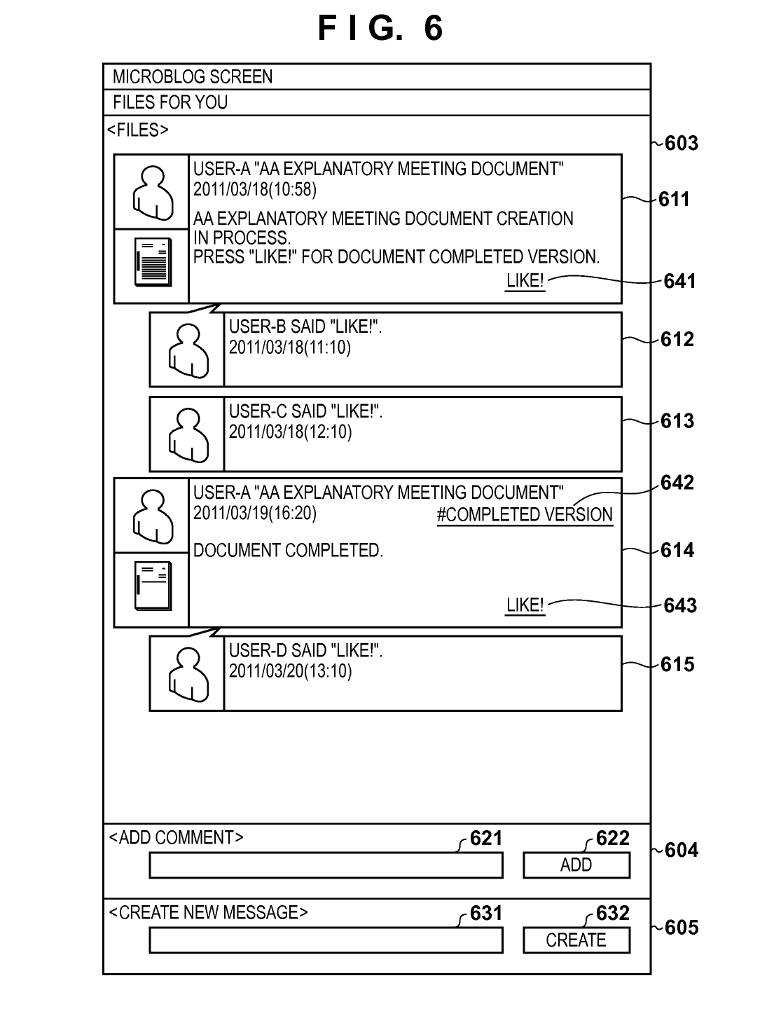

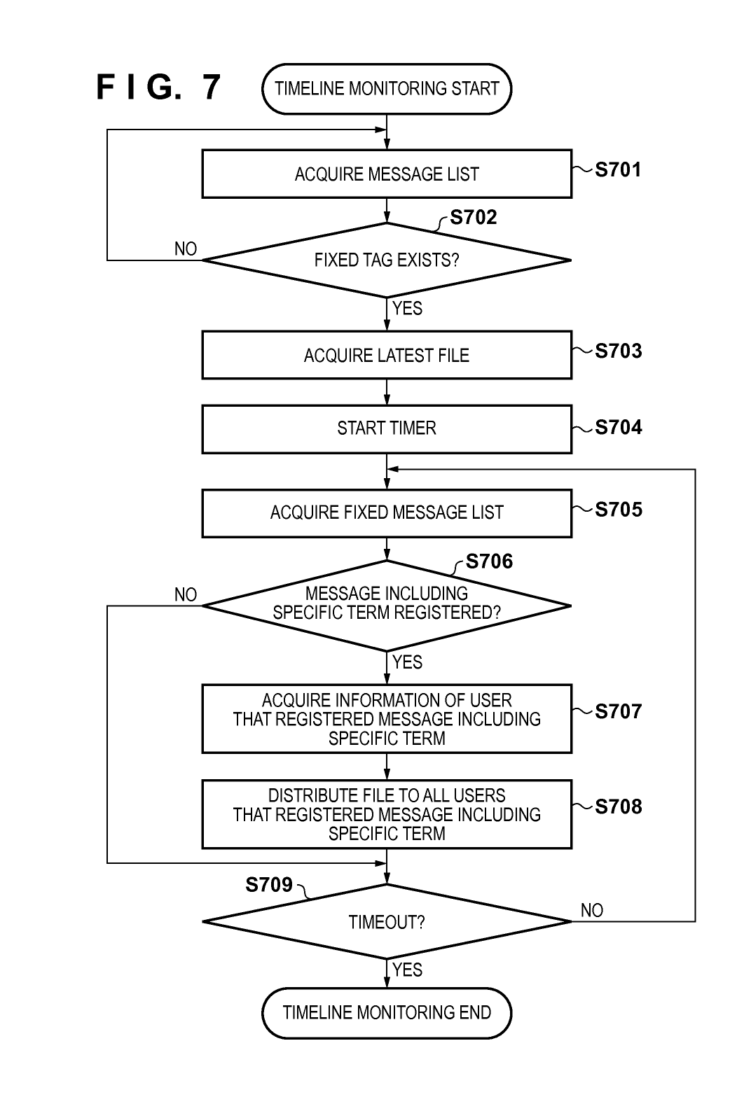

FIG. 6 is a view for showing an example of a microblog screen display on the terminal 102 according to a microblogging function provided by the cloud service server 131 according to the present embodiment.

The microblogging function is a function that makes available messages and files, that were registered by users from apparatuses that are connected so as to be able to communicate with the cloud service server 131, to other users on a plurality of other apparatuses. Normally, a message is between 150-200 characters. FIG. 6 is showing a display example of a Web page displayed upon an access of the cloud service server 131 from a Web browser operating on the terminal 102 (PC, etc.). In this example, the cloud service server 131 manages a file of a user that operates the terminal 102, a message related to the file, and a message corresponding to the file.

The screen example shown in FIG. 6 shows an example of a microblog screen on which the cloud service server 131 displays a message corresponding to a user of the terminal 102. The terminal 102, according to screen information it receives from the cloud service server 131, displays this microblog screen onto a display unit. In a message display area 603, a timeline displays messages, and messages from other users corresponding to these messages, of which it consists. The message display area 603 displays a state where a user “USER-A”, is managing a document file “AA EXPLANATORY MEETING DOCUMENT” using the microblogging function.

A message 611 is a first message which displays that the user “USER-A” registered the document file “AA EXPLANATORY MEETING DOCUMENT” (an original version of the file), which is in the process of being edited, and a message related to it. Messages 612 and 613, corresponding to the message 611, are fixed messages (second messages) registered when a user “USER-B” and a user “USER-C” respectively clicked a link button 641 (“LIKE!”) included in the message 611. Note, here a state is shown in which natural language having the meaning that “LIKE!” was clicked is registered, but even in a case where only the name of a user that clicked “like!” is registered, it is treated as a message having been registered.

A message 614 is a message (a first message) indicating that the user “USER-A” registered the completed document file “AA EXPLANATORY MEETING DOCUMENT” (an updated version of the file) and a message related to it. The difference with the previous message 611 is the point that a tag 642 (“#COMPLETED VERSION”) is attached to the message for registering the completed document file. A fixed message 615 corresponding to the message 614 is a fixed message registered when a user “USER-D” pressed (clicked) a link button 643 (“LIKE!”) included in the message 614.

Numeral 604 denotes a message input area, and when an operator of the terminal 102 enters a message in a message insertion field 621 and presses an ADD button 622, a message add request is transmitted from the Web browser to the cloud service server 131. The cloud service server 131, having received this request, registers the input message. With this, when a user accesses the cloud service server 131 with a Web browser, the registered message is displayed on the Web browser.

Numeral 605 denotes a new message input area, wherein when an operator of the terminal 102 enters a message into a message insertion field 631 and presses an CREATE button 632, a message creation request is transmitted from the Web browser to the cloud service server 131. The cloud service server 131, having received this request, newly registers the input message. With this, when a user accesses the cloud service server 131 with a Web browser, the created message is displayed on the Web browser in the same way as previously discussed messages 611 and 614.

Next, explanation of the details of timeline monitoring processing of the image processing apparatus 101 according to the present embodiment will be given with reference to FIG. 7. The processing explained below is realized by the CPU 211 of the image processing apparatus 101 loading a control program from the ROM 212 or the HDD 214 into the RAM 213 and executing it.

FIG. 7 is a flowchart for describing timeline monitoring processing by the image processing apparatus 101 according to the embodiment.

Firstly, in step S701, the microblog communication management section 402, via the communication section 401, acquires message list information from the cloud service server 131. This corresponds to acquiring the message 611 and the message 614 in the example screen shown in FIG. 6. Next, the processing proceeds to step S702, and the microblog communication management section 402 determines whether or not a specific tag (for example “#COMPLETED VERSION”) indicating a completed version of a document file related to the content of the acquired message is included the message. In a case where the microblog communication management section 402 determines that a specific tag indicating the status of the document file is included, the processing proceeds to step S703, and in a case where it determines that no specific tag is included, the processing returns to step S701, and message list information is periodically acquired. This corresponds to determining that the specific tag 642 (“#COMPLETED VERSION”) is included at a point in time when the message 614 is acquired in the example screen shown in FIG. 6. Accordingly, from the message 614, it would be determined that creation of the document file “AA EXPLANATORY MEETING DOCUMENT” has completed, and the processing would proceed from step S702 to step S703.

In step S703, the microblog communication management section 402, via the communication section 401, acquires the completed document file which was associated with the message that includes the specific tag from the cloud service server 131. Furthermore, the microblog communication management section 402 instructs the document file management section 403 to store the acquired document file along with the message ID in the document file DB 405. Here the message ID is an ID that uniquely identifies a message (the message 614 in FIG. 6) in which the specific tag is included.

Next the processing proceeds to step S704, and the microblog communication management section 402 starts the timer 222 in order to monitor for a fixed time period for fixed messages corresponding to the message (the message 614 in FIG. 6). Next, in step S705, the microblog communication management section 402, via the communication section 401, acquires list information of fixed messages corresponding to the message from the cloud service server 131. For example, in the example screen shown in FIG. 6, at the point in time where the message 614, that indicates that the document file “AA EXPLANATORY MEETING DOCUMENT” was completed, was registered (register time: 2011/03/19 (16:20)), messages that were previously registered are the fixed messages 612 and 613. Accordingly, here, the list information of the fixed message 612 (register time: 2011/03/18 (11:10)) and the fixed message 613 (register time: 2011/03/18 (12:10)) messages would be acquired.

Next, the processing proceeds to step S706, and the microblog communication management section 402 determines whether or not a fixed message including a specific term (for example, “LIKE!”) is registered within the fixed message list information acquired in step S705. In step S706, in a case where it is determined that a fixed message including a specific term exists, the processing proceeds to step S707, and when that is not the case, the processing proceeds to step S709. This corresponds to determining that the fixed messages 612 and 613 are fixed messages that include a specific term in the example screen shown in FIG. 6.

In step S707, the microblog communication management section 402, via the communication section 401, acquires information of the user that registered the fixed messages (612 and 613 in FIG. 6) from the cloud service server 131. In this user information is included information comprising attributes of the user. Attributes of the user may include, for example, a facial photograph, a name, contact details (a telephone number, an email address, an address, etc.), affiliated groups, a language, and so on. This corresponds to acquiring user information of the user “USER-B” and the user “USER-C” who registered the fixed messages 612 and 613 in the example screen shown in FIG. 6.

Next the processing proceeds to step S708, and the microblog communication management section 402 extracts a mail address each user information item acquired in step S707. Furthermore, the document file acquired from the cloud service server 131 in step S703 and stored in the document file DB 405 is acquired based on the message ID via the document file management section 403. Next, the microblog communication management section 402 generates electronic mail data attached to which is the acquired document file, and transmits the electronic mail data to the mail server 132 using the extracted mail addresses as the send destinations. This corresponds to electronic mails to which the completed version of the document file “AA EXPLANATORY MEETING DOCUMENT” is attached being sent to mail addresses of the user “USER-B” and the user “USER-C” in the example screen shown in FIG. 6.

Next, the processing proceeds to step S709, and it is determined whether or not the timer 222 started in step S704 has timed out. In a case where it is determined that the timer 222 has not yet timed out, the processing returns to step S705 and the processing of steps S705-S709 is repeated. In a case where it is determined that the timer 222 has timed out, the timeline monitoring processing completes.

There are cases when, on the second or more time that processing of steps S705-S709 is performed, in step S706, the microblog communication management section 402 detects a newly registered fixed message within the fixed time period of the timer 222. This corresponds to the fixed message 615 (register time: 2011/03/20 (13:10)) in the example screen shown in FIG. 6. In this case, in step S708, an electronic mail, attached to which is the completed version of the document file “AA EXPLANATORY MEETING DOCUMENT”, is transmitted to the user “USER-D” that registered the fixed message 615.

As explained above, according to the present embodiment, other users that wish to acquire the completed version of a document file in the process of being created, just by registering a fixed message on a microblog, can automatically acquire the completed version, upon which editing and updating is being performed, at the point in time when it is completed.

Also, according to the present embodiment, it is possible to more certainly distribute the completed version of the document file to only the users that want it, and it is possible to avoid it being distributed to an incorrect address.

Further, users that want to acquire the document file, for example, can register a fixed message simply by clicking a term (for example “LIKE!”), indicating that the completed version of the file is desired, included in a registered message associated with the document file. Because of this, there is the advantage that a user is able to acquire the completed version of a document file with simple operation.

### Other Embodiments

In the present embodiment, by clicking a message's “LIKE!”, for example, the message registered is a fixed message, but the present invention is not limited to this, and it could alternatively be another message that the image processing apparatus 101 can analyze. For example, as the analyzable message, a message such as “send e-mail to me as pdf” may be used, a transmission method (e-mail), a transmission destination (me) and a file format (pdf) being included in the message. In this case, the microblog communication management section 402 analyzes the registered message and converts the document file according to the specified file format, using the image processing section 406. It is then possible to transmit, via the communication section 401, the document file, to the indicated transmission destination by the indicated transmission method.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-138193, filed Jun. 19, 2012, which is hereby incorporated by reference herein in its entirety.

What is claimed is:

1. An information processing system comprising:
a detection unit configured to detect that an updated version of a file is registered on a server that provides a microblogging function;
an acquisition unit configured to acquire, in a case where the detection unit detected that the updated version of the file is registered on the server, information indicating a user that performed a specific operation related to an original version of the file; and
a distribution unit configured to distribute the updated version of the file to the user indicated by the information that the acquisition unit acquired.

2. The information processing system according to claim 1, wherein the specific operation is an operation corresponding to a message of the original version of the file that is registered on the server.

3. The information processing system according to claim 1, wherein in a case where the specific operation is performed, a message indicating that the specific operation is performed is registered on the server.

4. The information processing system according to claim 1, wherein the detection unit determines, in a case where a message, to which a predetermined tag is attached, is registered on the server, that the updated version of the file is registered on the server.

5. The information processing system according to claim 1, wherein the distribution unit transmits an electronic mail to which the updated version of the file is attached to a mail address included in the information acquired by the acquisition unit.

6. An information processing apparatus that communicates with a server that provides a microblogging function, the information processing apparatus comprising:
a detection unit configured to detect that an updated version of a file is registered on the server;
an acquisition unit configured to acquire, in a case where the detection unit detected that the updated version of the file is registered on the server, information indicating a user that performed a specific operation related to an original version of the file; and
a distribution unit configured to distribute the updated version of the file to the user indicated by the information that the acquisition unit acquired.

7. The information processing apparatus according to claim 6, wherein the specific operation is an operation corresponding to a message of the original version of the file that is registered on the server.

8. The information processing apparatus according to claim 6, wherein in a case where the specific operation is performed, a message indicating that the specific operation is performed is registered on the server.

9. The information processing apparatus according to claim 6, wherein the detection unit determines, in a case where a message, to which a predetermined tag is attached, is registered on the server, that the updated version of the file is registered on the server.

10. The information processing apparatus according to claim 6, wherein the distribution unit transmits an electronic mail to which the updated version of the file is attached to a mail address included in the information acquired by the acquisition unit.

11. A control method for controlling an information processing system, the control method comprising:
detecting that an updated version of a file is registered on a server that provides a microblogging function;
acquiring, in a case where in the detecting step it is detected that the updated version of the file is registered on the server, information indicating a user that performed a specific operation related to an original version of the file;
distributing the updated version of the file to the user indicated by the information acquired in the acquiring step.

12. A control method for controlling an information processing apparatus that communicates with a server that provides a microblogging function, the control method comprising:
detecting that an updated version of a file is registered on the server;
acquiring, in a case where in the detecting step it is detected that the updated version of the file is registered on the server, information indicating a user that performed a specific operation related to an original version of the file;
distributing the updated version of the file to the user indicated by the information acquired in the acquiring step.

13. A non-transitory computer-readable storage medium storing a program for causing a computer to function as an information processing system defined in claim 1.

14. A non-transitory computer-readable storage medium storing a program for causing a computer to function as an information processing apparatus defined in claim 6.
